(19) United States
(12) Patent Application Publication
(10) Pub. No.: US 2010/0081341 A1
(43) Pub. Date: Apr. 1, 2010

(54) PCB TERMINAL BLOCK

(76) Inventor: Shang Tsai WU, Taipei Hsien (TW)

Correspondence Address: BIRCH STEWART KOLASCH & BIRCH, PO BOX 747, FALLS CHURCH, VA, 22040-0747, US

(21) Appl. No.: 12/241,609

(22) Filed: Sep. 30, 2008

(51) Int. Cl. H01R 9/22

(52) U.S. Cl. 439/709

(57) ABSTRACT

A printed circuit board (PCB) terminal block includes a block body provided with side wings each having a stop rib, and a printed circuit board provided with a receiving opening formed with opposite positioning recesses. When the block body is inserted into the receiving opening of the printed circuit board, each of the stop ribs is engaged with a corresponding one of the positioning recesses to withstand a rotating force applied by a locking screw to the block body, thereby freeing a soldered terminal from the rotating force, so that the soldered terminal is less likely to be pushed and therefore become loose under action of the external force.

### BACKGROUND OF THE INVENTION

1. Technical Field

The present invention relates to an improved structure of a printed circuit board (PCB) terminal block, and more particularly, to a terminal block that can be assembled to a printed circuit board very securely to make terminals therein less likely to become loose.

2. Description of Related Art

As a core component of electronic products, a printed circuit board must be connected with external electronic components to form a complete circuitry. Therefore, various kinds of connectors are provided on the printed circuit board to connect with the external electronic components. Terminal blocks are just one of the various kinds of connectors. Referring to FIGS. 6 and 7, a block body 60 of a conventional PCB terminal block has a receiving space therein, and is formed with windows 61 at a front side, a top side and a back side thereof, respectively. An internal socket 70 disposed inside the block body 60 has one end threaded through by a locking screw 71 and the other end connected to a terminal 72. A distal end of the terminal 72 extends out of the block body 60 to be connected to a solder bump 51 on the printed circuit board 50.

However, as no special design is provided for the conventional PCB terminal block, when a cable or terminal to be connected is inserted from above the block body 60 (as indicated by a downward arrow in FIG. 7) and a screwdriver 41 is used to tighten the locking screw 71 from a side of the block body 60, a force rotating the locking screw 71 will be transmitted to the terminal 72 and further applied between the terminal 72 and the solder bump 51 on the PCB 50. Consequently, the solder bump 51 tends to crack or be stripped off, thereby causing short-circuit of signals. This is a prominent shortcoming of the conventional PCB terminal block.

### BRIEF SUMMARY OF THE INVENTION

The primary objective of the present invention is to provide a stop rib on a block body of a PCB terminal block so that when the block body of the PCB terminal block is assembled to a PCB, the stop rib is engaged with an edge of the PCB to withstand a rotating force applied by a locking screw to the block body, thereby freeing a soldered terminal from such rotating force. Thus, a feature of this invention is that the soldered terminal is less likely to be pushed and therefore become loose under action of the external force.

### BRIEF DESCRIPTION OF THE SEVERAL VIEWS OF THE DRAWINGS

The present invention as well as a preferred mode of use and advantages thereof will be best understood by referring to the following detailed description of an illustrative embodiment in conjunction with the accompanying drawings, wherein:

FIG. 1 is an exploded view illustrating a general structure of the present invention;

FIG. 2 is an exploded view illustrating a detailed structure of the present invention;

FIG. 3 shows an embodiment of the present invention in an assembled state;

FIG. 4 is a schematic cross-sectional side view of the present invention whereon a force generated by using a screwdriver is applied;

FIG. 5 is an additional schematic cross-sectional top view of the present invention showing stop ribs and positioning recesses receiving the force generated by using the screwdriver;

FIG. 6 is an exploded view illustrating a structure of a conventional PCB terminal block; and

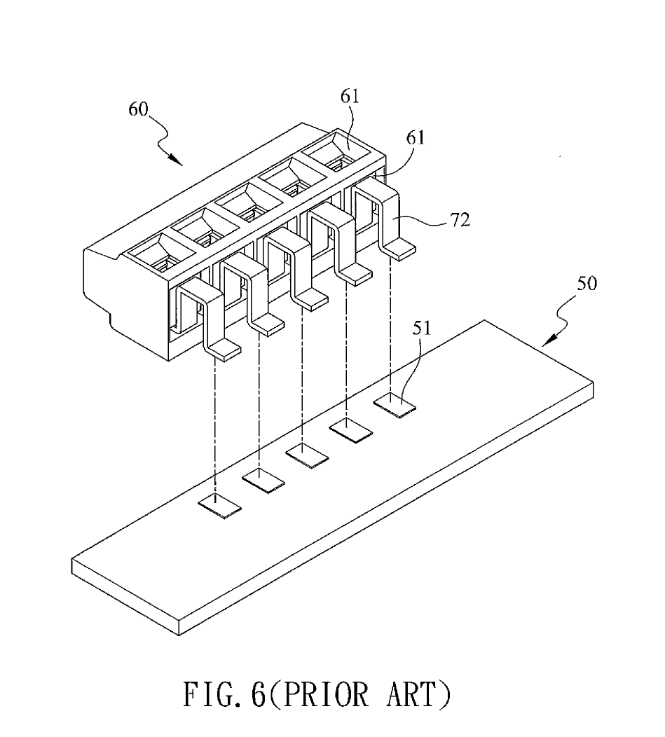

FIG. 7 is a schematic view illustrating a terminal subject to a force applied to the conventional PCB terminal block.

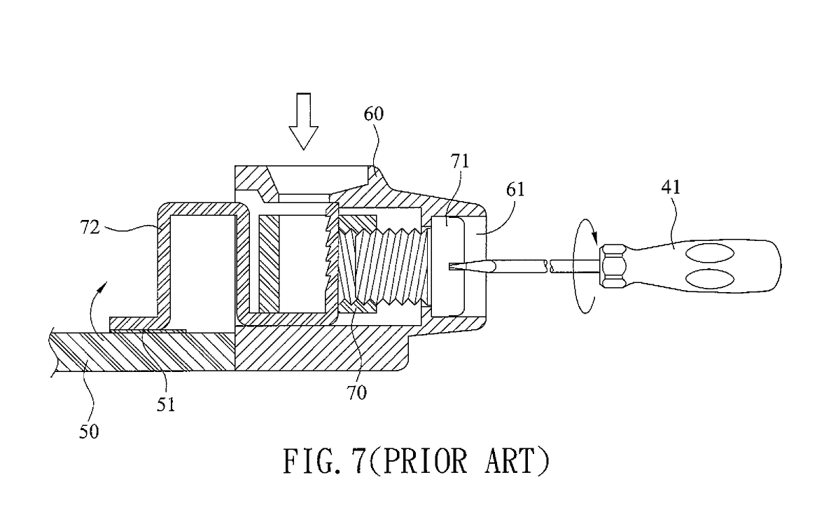

### DETAILED DESCRIPTION OF THE INVENTION

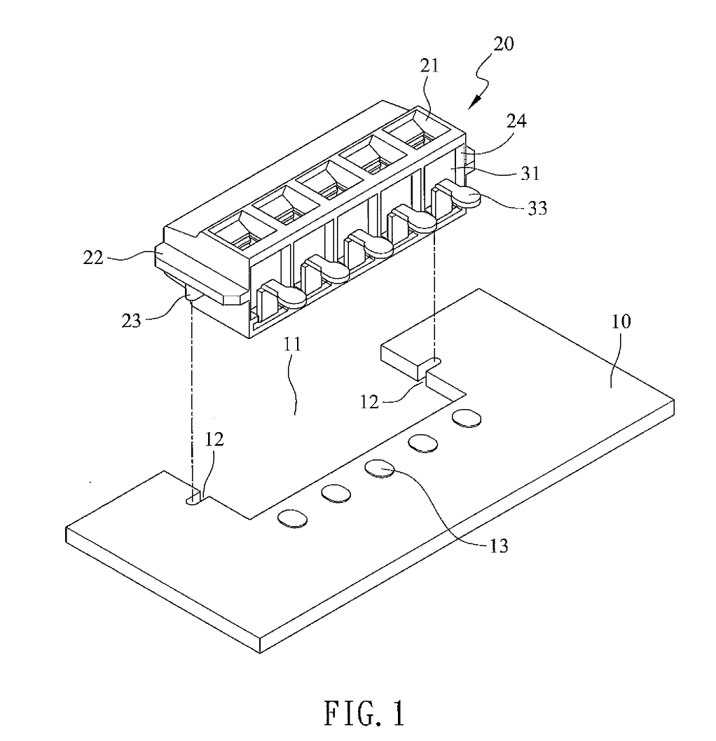

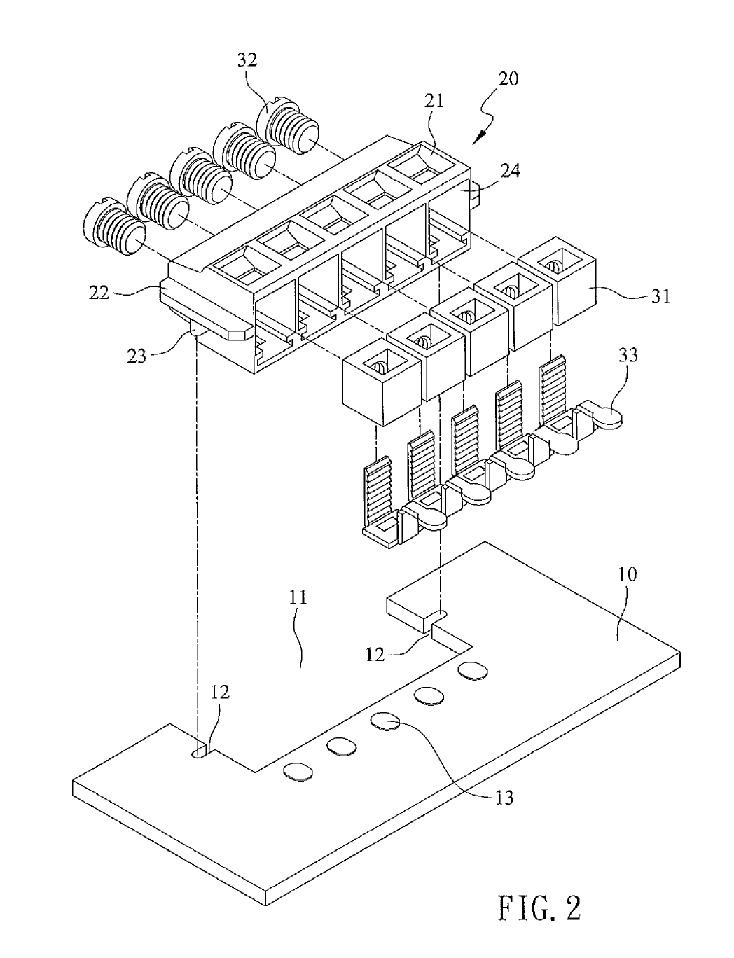

Referring to FIGS. 1 and 2, a PCB terminal block of this invention primarily comprises a printed circuit board 10 and a block body 20.

The printed circuit board 10 has a receiving opening 11 disposed at a side edge thereof, wherein the receiving opening 11 is formed with positioning recesses 12 at at least two sides thereof, respectively.

The block body 20 is formed with side wings 22 protruding from two outer ends thereof, respectively. A stop rib 23 is formed below each of the side wings 22, wherein the stop ribs 23 may be provided either singularly or in pairs, depending on practical requirements rather than being limited to what is depicted herein. The block body 20 has a receiving space therein, and is formed with a first window 21, a second window 24 and a third window 25 at a front side, a top side and a back side thereof, respectively. A group of conductive elements 30 comprising an internal socket 31, a locking screw 32 and a terminal 33 are assembled in the block body 20, wherein the internal socket 31 has one end penetrated by the locking screw 32 and the other end connected to the terminal 33. A distal end of the terminal 33 extends out to be soldered to a solder bump 13 on the printed circuit board 10.

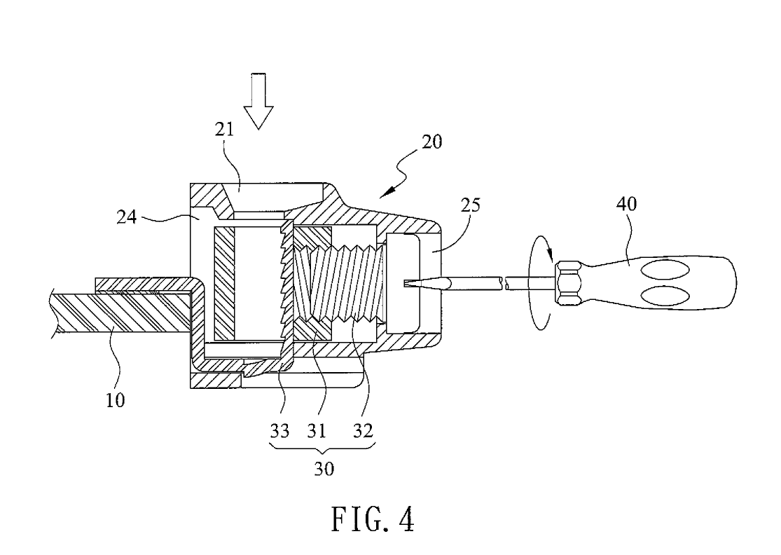

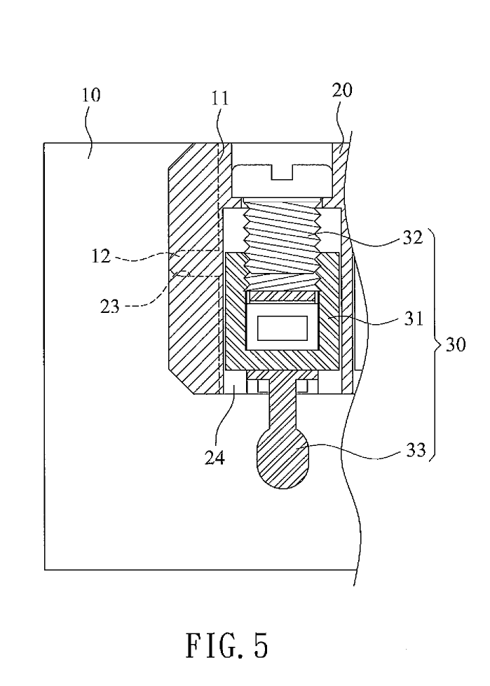

The block body 20 is disposed in the receiving opening 11, so that the side wings 22 extend beyond and above two ends of the receiving opening 11, and the stop ribs 23 are inserted exactly into the positioning recesses 12. Thus, the block body 20 is snap-fitted with the printed circuit board 10 and prevented from rotating. Referring to FIGS. 2, 4 and 5, when a cable or terminal to be connected is inserted from above the block body 20 (as indicated by the downward arrow in FIG. 4) and a screwdriver 40 is used to tighten the locking screw 32 from a side of the block body 20, a force rotating the locking screw 32 will be transmitted to the stop ribs 23 on both sides of the block body 20 and the positioning recesses 12 instead of the terminal 33. Consequently, as an advantage of the present invention, the block body 20 can be securely assembled to the printed circuit board 10 and is less likely to be damaged by the external force.

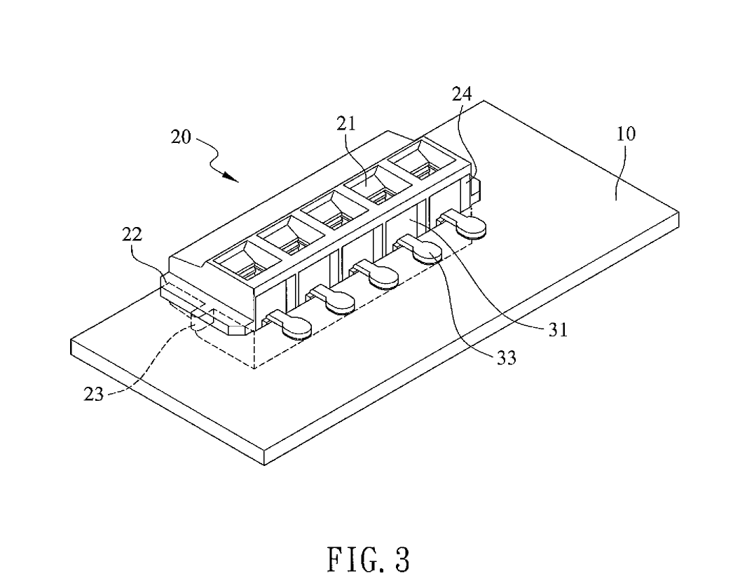

Additionally, as shown in FIGS. 1 and 3, the block body 20 is fitted in the receiving opening 11 with about a half of the height of the block body 20 below the printed circuit board 10. Consequently, the stop ribs 23 at both sides of the block body 20 are located close to an extension line of the force applied by the locking screw 32 and are thus less likely to be rotated by the torque. Moreover, as another advantage of the present invention, the PCB terminal block of the present invention has a reduced height above the printed circuit board 10.

The attached drawings are only illustrative of a preferred embodiment of this invention. Therefore, slight modifications in exterior design of the present invention that do not depart from the main concepts disclosed herein still fall within the scope of this application. It follows from the above description that the present invention meets the requirements of novelty, utility and industrial applicability for patent application. Hence, an application for patent of the present invention is hereby lawfully filed for examination.

1. A printed circuit board (PCB) terminal block, comprising:
a printed circuit board formed with a receiving opening at a side edge thereof, the receiving opening formed with at least one positioning recess at each of two sides thereof; and
a block body formed with a receiving space therein, in which at least a group of conductive elements comprising an internal socket, a locking screw and a terminal are provided in the receiving space, and a side wing formed with a stop rib is protrudingly provided at each of two outer ends of the block body, wherein the block body is disposed in the receiving opening with the side wings extending beyond and above two ends of the receiving opening, respectively, so that the stop ribs are inserted exactly in the positioning recesses.

2. The PCB terminal block of claim 1, wherein each of the stop ribs is disposed below a corresponding one of the side wings.

3. The PCB terminal block of claim 1, wherein the stop ribs are provided in pairs.
